(19) United States
(12) Patent Application Publication
(10) Pub. No.: US 2012/0160049 A1
(43) Pub. Date: Jun. 28, 2012

(54) TRANSMISSION SHIFTER WITH REDUCED CROSS CAR TRAVEL

(76) Inventor: Brian William Fett, Spring Lake, MI (US)

(21) Appl. No.: 13/332,943

(22) Filed: Dec. 21, 2011

Related U.S. Application Data
(60) Provisional application No. 61/426,557, filed on Dec. 23, 2010.

(51) Int. Cl. G05G 9/00

(52) U.S. Cl. 74/473.1

(57) ABSTRACT

A transmission shifter for a vehicle includes a base, a transmission shift lever, a cable bracket adapted for connection to a transmission control member, and a yoke. The yoke and the cable bracket are assembled and define a first pivot axis on the base. The shift lever is pivoted to the yoke for movement about a second pivot axis generally perpendicular to the first pivot axis. The shift lever and the cable bracket include vertically-elongated mating engagement features that, when the shift lever is in a fully engaged position, lock the shift lever and the cable bracket together preventing relative movement therebetween. The shift lever is movable from the fully engage position to a partially disengaged position where the mating engagement features are sufficiently disengaged to permit at least limited movement of the shift lever without concurrent movement of the cable bracket.

### CROSS-REFERENCE TO RELATED APPLICATION

This application claims benefit under 35 U.S.C. §119(e) of provisional application Ser. No. 61/426,557, filed Dec. 23, 2010, entitled TRANSMISSION SHIFTER WITH REDUCED CROSS CAR TRAVEL.

### BACKGROUND

The present invention relates to transmission shifters for vehicles, and more particularly relates to a shifter moveable along an automatic shift path including park, reverse, neutral, and drive positions and along a manual shift path including an up shift position and a down shift position.

On known automatic transmission shifter with manual shift mode is disclosed in Rempinski U.S. Pat. No. 5,791,197. This shift lever is moveable along an automatic shift path including park, reverse, neutral, and drive shift positions, and movable along a transverse path to a parallel manual shift path including an up shift position and a down shift position. The shift lever when moved in either the automatic shift path or the manual shift path pivots about a cross-car horizontal axis defined by a pin 60 and sphere 59 and socket-shaped bearing 52. The shift lever in Rempinski '197 when moved between the automatic and manual shift paths is movable about a fore-aft horizontal axis defined by the sphere 59/socket-shaped bearing 52 and that is perpendicular to the first cross-car horizontal axis. For example, see FIG. 13 in U.S. Pat. No. 5,791,197 which discloses shift paths 36 (automatic shift path), 37 (manual shift path), and 38 (transition path between shift paths), and also the engagement structure of the U-shaped member 70/72 and the shifter engagement block 61 (FIGS. 6 and 9).

A problematic dilemma occurs as shifters become more compact, and as shifters have reduced travel due to their compact size. For example, the engagement structure permitting operation of the shift lever in its various shift positions must be sufficiently small to allow disengagement of the transmission control cable/transmission rod/linkage for operation of the shifter when in the manual shift path, yet sufficiently large to provide sufficient engagement structure and movement to operate the transmission control cable/transmission rod/linkage for operation of the shifter when in the automatic shift path. This dilemma is not easily solved, particularly given the relatively complex nature of modern transmission shifters, and the structural requirements and durability requirements of modern transmission shifters.

### SUMMARY OF THE PRESENT INVENTION

In one aspect of the present invention, a transmission shifter for a vehicle includes a base, a transmission shift lever with lever component, a cable bracket adapted for connection to a transmission control member, and a yoke. The yoke and the cable bracket are assembled and define a first pivot axis on the base. The shift lever is pivoted to the yoke for movement about a second pivot axis generally perpendicular to the first pivot axis. The lever component and the cable bracket include mating engagement features that, when the shift lever is in a fully engaged position, lock the shift lever and the cable bracket together preventing relative movement therebetween. The shift lever is movable from the fully engage position to a disengaged position where the mating engagement features are sufficiently disengaged to permit movement of the shift lever without concurrent movement of the cable bracket.

In another aspect of the present invention, a transmission shifter for a vehicle includes a base, a transmission shift lever including an engagement feature, a cable bracket adapted for connection to a transmission control member and including a mating engagement feature, and a yoke. The yoke and the cable bracket being assembled and defining a first pivot axis on the base with the engagement features being less than 50 mm from the first pivot axis. The shift lever is pivoted to the yoke for movement about a second pivot axis generally perpendicular to the first pivot axis with pivoting movement of the shift lever being limited by the base and yoke and cable bracket to a rotational angle of less than 7 degrees, the engagement features being shaped to disengage with a disengagement movement of less than 5 mm. The engagement features lock the shift lever and the cable bracket together preventing relative movement therebetween when in a fully engaged position. The shift lever are movable from the fully engaged position to a partially disengaged position where the mating engagement features are sufficiently disengaged to permit movement of the shift lever without concurrent movement of the cable bracket.

These and other aspects, objects, and features of the present invention will be understood and appreciated by those skilled in the art upon studying the following specification, claims, and appended drawings.

### BRIEF DESCRIPTION OF DRAWINGS

FIGS. 1-3 are side schematic views illustrating the problem solved by the present inventive transmission shifter, including FIG. 1 which illustrates movements like an existing production shifter in prior art, FIG. 2 which is modified to have an engagement feature much closer to the pivot axis of the shift lever (one aspect of the present invention), and FIG. 3 which is modified to have an engagement feature that is both much closer to the pivot axis and also much shorter angular throw of the shift lever.

FIG. 4 is a perspective view of a shift lever assembly including an over-molded lever component, a cable bracket connected to a transmission shift cable, and a yoke, the lever component including a shouldered protrusion engagement feature and the cable bracket including a lever engagement feature (T-shaped recess) for engaging and disengaging the protrusion.

FIG. 5 is a cross section taken along line V-V in FIG. 4, with the cable bracket tipper outward to pull protrusion sufficiently to remove the shoulders of the protrusion from the recess but allowing a tip of the protrusion to move between and engage wide portions of the recess (thus allowing limited fore-aft movement of the shift lever when in the manual shift mode and effectively preventing movement of the cable bracket).

FIG. 6 is a cross section similar to FIG. 5 (taken along line V-V in FIG. 4), but with the protrusion fully engaging the recess such that the protrusion is locked in the recess (thus locking movement of the cable bracket to the shifter and preventing any relative fore-aft movement when in the automatic shift mode).

FIG. 7 is a perspective view similar to FIG. 4 but with the shift lever pivoted to engage the engagement features.

FIG. 8 is an exploded view of the shift lever in FIGS. 4 and 7.

FIG. 9 is a schematic view of a shift path including a shift lever's movement along an automatic shift path, a manual shift path, and also a transition path between the automatic shift path and the manual shift path.

FIG. 10 is a schematic of the present shifter including a base and the present shift lever pivoted thereto for movement along the automatic shift path, the manual shift path, and also the transition path therebetween.

FIG. 11 is a front view of the present shift lever in FIG. 10 when in the automatic shift path, and showing engagement of the protrusion and recess to lock the cable bracket to the shift lever.

FIG. 12 is a cross section through the protrusion and showing the recess in FIG. 11.

FIG. 13 is a front view of the present shift lever in FIG. 10 when in the manual shift path, and showing partial disengagement of the protrusion and recess to provide limited movement of the shift lever without moving the cable bracket.

FIG. 14 is a cross section through the protrusion and showing the recess in FIG. 13.

### DETAILED DESCRIPTION OF PREFERRED EMBODIMENTS

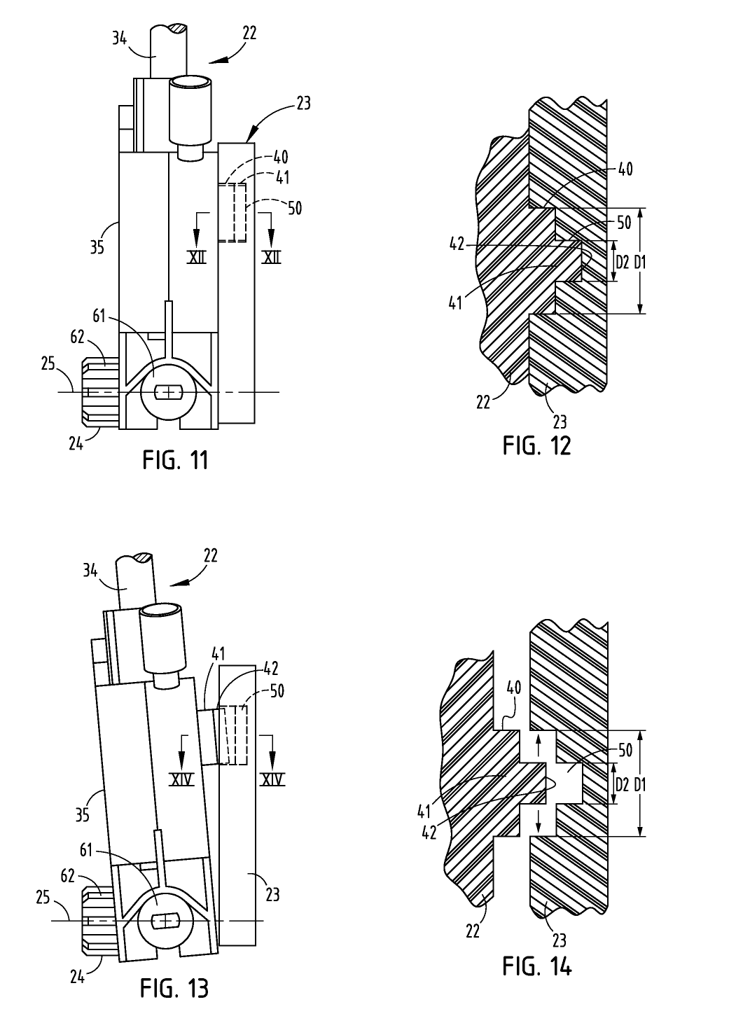

The present vehicle transmission shifter 20 (FIG. 10) includes a base 21, a shift lever 22, a cable bracket 23, and a yoke 24. The shift lever 22 is moveable along an H-shaped shift pattern (FIG. 9), including an automatic shift path 28 (with gear positions park, reverse, neutral, drive, and manual-access position), a manual shift path 29 (with gear positions up-shift, down-shift and neutral), and a transition path 30 therebetween. As described below, when assembled and in the automatic shift path 28 (FIG. 9), engagement mating features 40/50 on the shift lever 22 and the cable bracket 23 engage and cause the shift lever 22 and cable bracket 23 and yoke 24 pivot as a unit about a cross-car horizontal axis 25 (FIGS. 9-12) to actuate a transmission control cable/rod/linkage 48 to shift between the gear positions PRND. The shift lever 22 can be pivoted about axis 26 to move from the automatic shift path 28 along transverse shift path 30 (FIG. 9) to the manual shift path 30 for up and down shifting (i.e. + and − shifting). When in the manual shift path 29 (FIGS. 9, 13-14), the engagement mating features 40/50 on the shift lever 22 and the cable bracket 23 disengage such that the shift lever 22 is released from the cable bracket 23, such that the shift lever 22 can be pivoted by itself about the axis 25 along the manual shift path 29 (without moving the cable bracket 23). The shift lever 22 can also pivot by itself about a fore-aft horizontal axis 26 along a transition path 30 (FIG. 9), which allows the shift lever 22 to release (or engage) the cable bracket 23. (Compare FIGS. 11-12 and 13-14.)

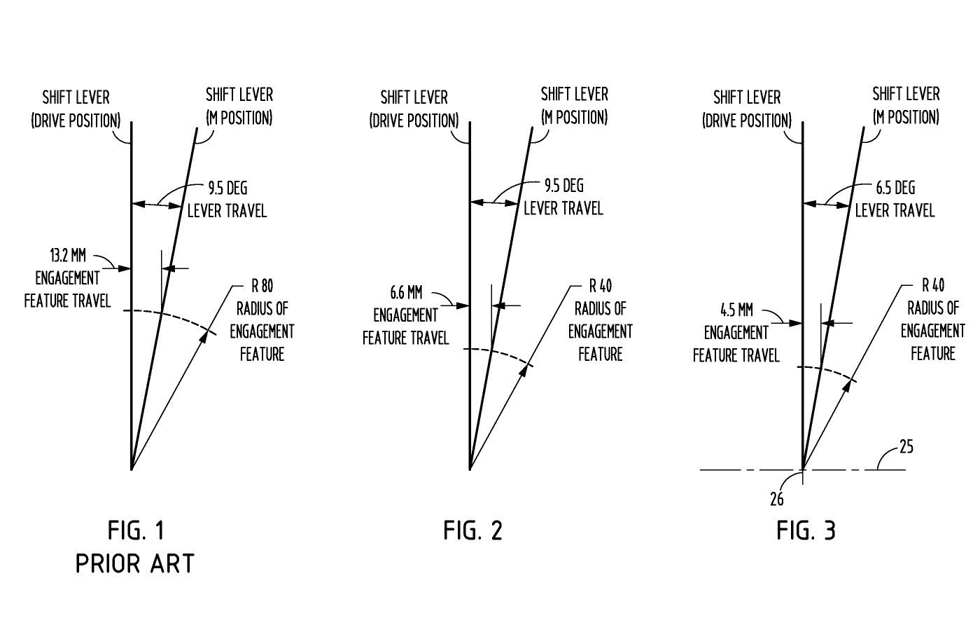

FIG. 1 is a schematic of a current production (prior art) shifter showing a shift lever's movement when moved along a transition path between an automatic shift path and a manual shift path, including data relating to engagement and disengagement of components during this movement. Notably, in this schematic, the distance of the transition path P1 is about 13.2 mm when the shift lever pivots an angle A1 of about 9.5 degrees and when the engagement feature is at a radius R1 of about 80 mm from the axis of rotation of the shift lever. Smaller shifter encounter limitations both in the distance that an engagement feature is from a pivot point of the shift lever, and also in the angular rotation that the shift lever can undergo. The distance limitation is illustrated in FIG. 2, and the combination of distance limitation and angular limitation are illustrated in FIG. 3.

FIG. 2 is a schematic similar to FIG. 1 but showing requirements of a compact shifter where the shift lever is limited to a shorter movement and showing related data. Specifically, in FIG. 2, the distance of the transition path P2 is only about 6.6 mm when the shift lever pivots an angle A2 of about 9.5 degrees because the engagement feature is limited to a radius R2 of about 40 mm from the axis of rotation of the shift lever.

FIG. 3 is a schematic similar to FIG. 2 but showing a compact shifter 20 of the present invention where the shift lever 22 has a further reduced travel and showing related data. Specifically, in the shifter 20 illustrated in FIG. 3, the distance of the transition path P3 is less than about 5 mm (such as only about 4.5 mm) because the shift lever can pivot an angle A3 less than about 7 degrees (such as only about 6.5 degrees) and also the engagement feature is limited to a radius R3 of less than about 50 mm (such as about 40 mm) from the axis of rotation of the shift lever.

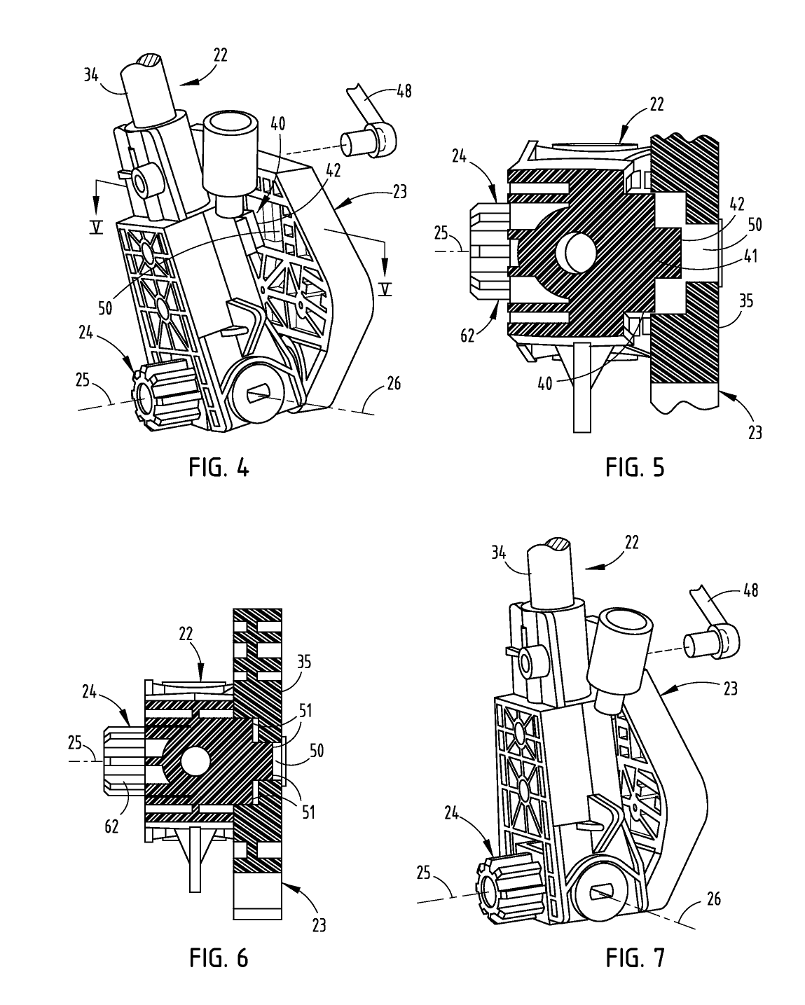

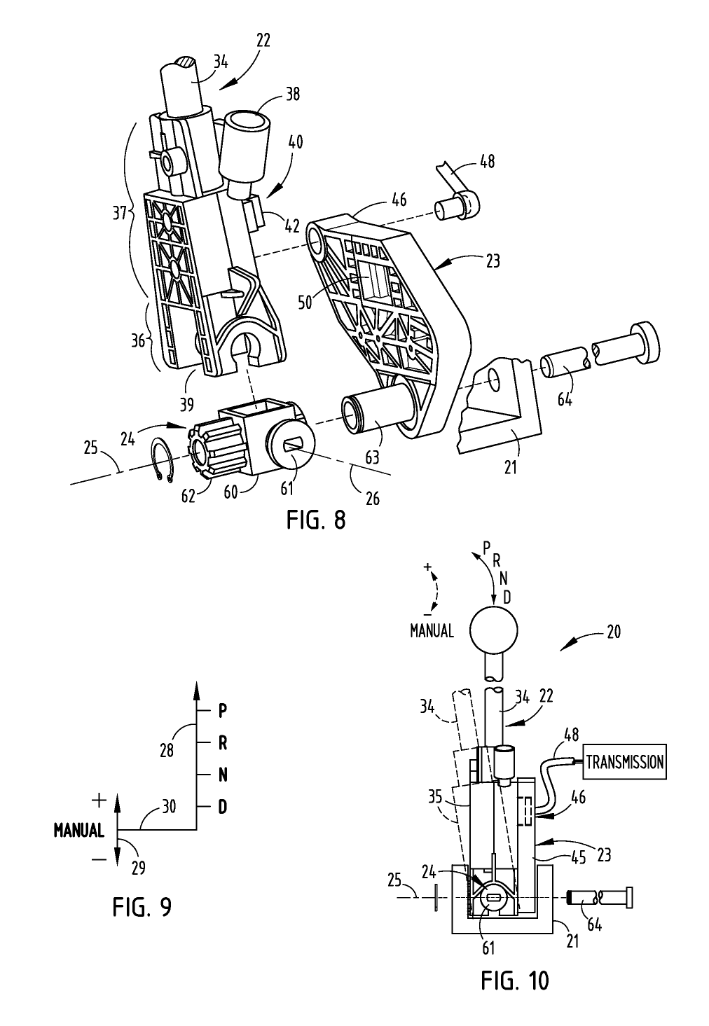

FIG. 4 is a perspective view of a shifter 20 (also called a shifter assembly) including the base 21, shift lever 22, the cable bracket 23, and the yoke 24. The shift lever 22 (FIG. 8) includes a tubular post or shaft 34 (steel or other material of suitable strength), and an over-molded lever component 35 of polymeric material on a lower end of the shaft 34. The over-molded lever component 35 includes sufficient ribs and other structure to be rigid enough for its intended purpose. It is contemplated that the polymeric material can be any structural polymer having adequate properties, such as nylon (polyamide). The component 35 includes a pivot-defining portion 36, a body portion 37, and an electrical accessory attachment feature 38 (such as for mounting a pawl-lock or other electrical device on the shift lever 22). The pivot-defining portion 36 includes opposing arms forming a space 39 therebetween for the yoke 24. The component 35 further includes a vertically-elongated shouldered protrusion 40 (also called “engagement mating feature”) with shoulders 41 and a tip 42 that form a T-shaped cross section. The shoulders 41 and tip 42 and also the T-shaped recess 50 (also called a “mating engagement feature”) are elongated sufficiently and otherwise designed in shape and size to provide the surface area and support structure required to prevent undesired wear during use of the shifter 20 (i.e., based on thousands of cycles of operating the control cable/linkage 48).

It is noted that these abutting surfaces of mating engagement features 40/50 can be elongated and otherwise sized as necessary for a particular vehicle application, as per OEM vehicle functional requirements and specifications, but also that they can be miniaturized to provide a smallest possible shift lever travel while also meeting functional wear and stress-related requirements. Also, it is contemplated that the protrusion 40 and recess 50 can be switched on the component 35 and cable bracket body 45. As illustrated, a size of a lower portion of the stepped protrusion 40 is 14 mm×20 mm (including its shoulders) (and can be any reasonable height such as about 7 mm high), and a size of the upper portion of the protrusion 40 (i.e. the tip) is 7 mm×14 mm×11 mm wide. (The 14 mm on the protrusion's tip extends parallel the 14 mm on the lower portion, and the 11 mm on the protrusion's tip extends parallel the 20 mm on the lower portion and in a center thereof, such that the shoulder width is about 4.5 mm on each side.) The recess is matingly sized and shaped, including any clearance required. By vertically elongated the mating engagement features 40/50, increased surface area and structure can be provided to resist undue wear and provide increased product life.

The cable bracket 23 (FIG. 8) includes a molded body 45 of polymeric material (such as polyamide polymeric material) with sufficient ribs and other structure to be rigid enough for its intended purpose. A cable-anchor 46 such as a ball-ended pin or linkage-connector is attached to the body 45 for attachment to the transmission control cable/linkage 48. A channel-shaped recess 50 (FIGS. 12, 14) (also called “engagement feature”) is shaped receive the protrusion 40, and its cross section includes a wide dimension D1 matching the shoulders 41 and a narrow dimension D2 matching the tip 42. The recess 50 (FIGS. 11-12) matably fully engages the protrusion 40 to provide a rigid solid connection with sufficient surfaces engaging to provide the support necessary to move the shift lever 22 and cable bracket 23 together to thus operate the transmission control cable/linkage.

Four locations 51 of engagement (i.e. four enlarged/elongated abutting surfaces, two pair in each direction) are shown in FIG. 6 when the protrusion 40 is fully seated into the recess 50. Alternatively, when the protrusion 40 is partially withdrawn (FIGS. 13-14) (i.e. the shift lever 22 is pivoted along the transition path 30 from the automatic shift path 28 to the manual shift path 29, only the tip 42 is positioned in the recess 50, and only at a depth sufficient so that the tip 42 engages the wide dimension of the recess 50. Thus, the tip 42 (i.e. the shift lever 22) is permitted to move a limited distance (i.e. the distance D1 minus the width of the tip 42) while the cable bracket 23 remains stationary. Since the protrusion 40 and recess 50 are vertically elongated, the amount of surface area of engagement is relatively large, even though the distance of movement into (or out of) engagement is quite small, as shown in FIG. 3. By designing a width size of the tip 42 and of the shoulders 41 (and of the surfaces in the mating recess 50), the limited distance can be made to be basically any length desired, while still providing the abutting surface area desired.

FIG. 5 is a cross section taken along line V-V in FIG. 4, with the protrusion 40 pulled sufficiently to remove the shoulders 41 of the protrusion 40 from the recess 50 but allowing a tip 42 of the protrusion 40 to engage wide portions of the recess 50 (thus allowing limited fore-aft movement of the shift lever 22 when in the manual shift path 29 and effectively preventing undesired movement of the cable bracket 23).

There is an additional more subtle advantage of the stepped shoulder protrusion 40 and mating recess 50. Due to the reduced size of the present shifter and components, there is insufficient room to put side structure along the transitional path 30 (FIG. 9) to define sides of the transitional path 30. Restated, the shift lever 22 moves such a short distance along transitional path 30, that any side structure forming a gate to force the shift lever 22 to stay along the transitional path 30 interferes with movement of the shift lever 22 when trying to move the shift lever 22 along one of the automatic shift path 28 or the manual shift path 29. Contrastingly, the tip 42 of the protrusion 40 allows movement to “+” and “−” positions along manual shift 29 (FIG. 9), and causes the movement along transitional path 30 to stay in the defined path (i.e. as the tip 42 engages the smaller portion of the recess 50, the tip 42 forces the shift lever 22 to stay on path 30).

FIG. 6 is a cross section similar to FIG. 5 (taken along line V-V in FIG. 4), but with the protrusion 40 fully engaging the recess 50 such that the protrusion 40 is locked in the recess 50 (thus locking movement of the cable bracket 23 to the shift lever 22 and preventing any relative fore-aft movement when in the automatic shift mode 28).

FIG. 8 is an exploded view of the shift lever 22 in FIGS. 4 and 7. The yoke 24 includes a block portion 60 that fits in space 39 between the arms of the pivot-defining portion 36 of the shift lever 22, and includes opposing circular protrusions 61 that rotatably engage the arcuate surfaces of the arms to pivotally support the shift lever 22 for movement about the axis 26. An axle-defining stub 62 extends laterally from the block portion 60. A tube 63 (such as a metal hollow tube or shaft) is attached to a lower end of the body of the cable bracket 23 and extends laterally through the block portion 60 and partially into the axle-defining stub 62. The tube 63 and axle-defining stub 62 define aligned holes that receive an axle pin 64 for pivotally supporting the shift lever 22 on the base 21 for fore-aft pivoting movement. The axle pin 64 defines axis 25.

FIG. 9 is a schematic view of the H-shaped shift path including a shift lever's movement along an automatic shift path 28, a manual shift path 29, and also a transition path 30 between the automatic shift path 28 and the manual shift path 29.

FIG. 10 is a schematic of the present shifter 20 including the base 21 and the present shift lever 22 pivoted thereto for movement along the automatic shift path 28, the manual shift path 29, and also the transition path 30 therebetween.

FIG. 11 is a front view of the present shift lever 22 in FIG. 10 when in the automatic shift path 28, and showing engagement of the protrusion 40 and recess 50 to lock the cable bracket 23 to the shift lever 22.

FIG. 12 is a cross section through the protrusion 40 and showing the recess 50 in FIG. 11.

FIG. 13 is a front view of the present shift lever 22 in FIG. 10 when in the manual shift path 29, and showing partial disengagement of the protrusion 40 and recess 50 to provide limited movement of the shift lever 22 without corresponding moving the cable bracket 23. It is contemplated that the disengagement can be partial disengagement (where the tip 42 remains partially in a wider part of the recess 50) or a full complete disengagement (where the tip 42 and shoulders 41 are completely pulled out of the recess 50). This of course depends on functional requirements and limitations on movement of the shift lever by the vehicle manufacturer.

FIG. 14 is a cross section through the protrusion 40 and showing the recess 50 in FIG. 13.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A transmission shifter for a vehicle comprising:
a base;
a transmission shift lever including a lever component;
a cable bracket adapted for connection to a transmission control member; and
a yoke;
the yoke and the cable bracket being assembled and defining a first pivot axis on the base;
the shift lever being pivoted to the yoke for movement about a second pivot axis generally perpendicular to the first pivot axis;
the lever component and the cable bracket including mating engagement features that, when the shift lever is in a fully engaged position, lock the shift lever and the cable bracket together preventing relative movement therebetween;
the shift lever being movable from the fully engage position to a disengaged position where the mating engagement features are sufficiently disengaged to permit movement of the shift lever without concurrent movement of the cable bracket.

2. The shifter defined in claim 1, wherein the engagement features are both formed by polymeric materials.

3. The shifter defined in claim 1, wherein the engagement features are vertically elongated.

4. The shifter defined in claim 1, wherein the engagement features include a protrusion and matingly shaped recess.

5. The shifter defined in claim 4, wherein the protrusion is stepped.

6. The shifter defined in claim 4, wherein the protrusion is T shaped.

7. The shifter defined in claim 1, wherein the cable bracket is a molded body.

8. The shifter defined in claim 1, wherein the shift lever shaft comprises a metal tube.

9. The shifter defined in claim 1, wherein one of the engagement features has a height of less than about 5 mm, and wherein the other of the engagement features is a recess with a depth and shape configured to fully receive the one engagement feature and to disengage from the one engagement feature with less than 5 mm separation movement of the engagement features.

10. The shifter defined in claim 1, wherein the base, the shift lever and the cable bracket limit pivoting movement of the shift lever to less than 7 degrees, and wherein the engagement features are less than about 50 mm from the pivot point of the shift lever.

11. The shifter defined in claim 1, wherein the lever component is over-molded onto the shift lever and includes polymeric material.

12. A transmission shifter for a vehicle comprising:
a base;
a transmission shift lever including an engagement feature;
a cable bracket adapted for connection to a transmission control member and including a mating engagement feature; and
a yoke;
the yoke and the cable bracket being assembled and defining a first pivot axis on the base and with the engagement features being less than 50 mm from the first pivot axis;
the shift lever being pivoted to the yoke for movement about a second pivot axis generally perpendicular to the first pivot axis with pivoting movement of the shift lever being limited by the base and yoke and cable bracket to a rotational angle of less than 7 degrees, the engagement features being shaped to disengage with a disengagement movement of less than 5 mm;
the engagement features locking the shift lever and the cable bracket together preventing relative movement therebetween when in a fully engaged position; and
the shift lever being movable from the fully engaged position to a partially disengaged position where the mating engagement features are sufficiently disengaged to permit movement of the shift lever without concurrent movement of the cable bracket.

13. The shifter defined in claim 12, wherein the engagement features are both formed by polymeric materials.

14. The shifter defined in claim 12, wherein the engagement features are elongated away from the first and second pivot axes.

15. The shifter defined in claim 12, wherein the engagement features include a protrusion and matingly shaped recess.

16. The shifter defined in claim 15, wherein the protrusion is stepped.

17. The shifter defined in claim 15, wherein the protrusion is T shaped.
